(19) United States
(12) Patent Application Publication
(10) Pub. No.: US 2004/0001135 A1
(43) Pub. Date: Jan. 1, 2004

(54) Recording medium

(76) Inventor: Yoshiya Soga, Osaka (JP)

Correspondence Address: BIRCH STEWART KOLASCH & BIRCH, PO BOX 747, FALLS CHURCH, VA, 22040-0747, US

(21) Appl. No.: 10/459,466

(22) Filed: Jun. 12, 2003

(30) Foreign Application Priority Data
Jun. 28, 2002 (JP) 190678/2002

(51) Int. Cl. B41J 3/407

(52) U.S. Cl. 347/106

(57) ABSTRACT

A recording medium (or sheet) is prepared by forming a porous layer, for forming an image, on at least one side of a support, in which the porous layer comprises an alicyclic epoxy compound. The alicyclic epoxy compound may have a plurality of epoxy groups, and for example, may include an epoxycycloalkylalkyl-epoxycycloalkane carboxylate. The mean pore size of the porous layer is about 0.1 to 20 μm, and the porosity thereof is about 20 to 85%. A resin constituting the porous layer may comprise a cellulose-series resin or the like, and may have a microphase-separated structure. In the porous layer, the amount of the alicyclic epoxy compound is about 1 to 200 parts by weight relative to 100 parts by weight of the resin constituting the porous layer. The recording sheet ensures forming of a clear image, and improved scratch resistance.

### FIELD OF THE INVENTION

The present invention relates to a recording medium (sheet) which is suitable for a thermal-transfer recording system [e.g., a thermofusible (or hot-melt) transfer recording system (or thermal wax (or resin) transfer printer), a sublimation-mode thermal-transfer system] or an ink jet recording system, and a method for producing thereof.

### BACKGROUND OF THE INVENTION

In recent years, mobile electrical or communication apparatuses (or devices) (e.g., a digital camera, a potable telephone) has been remarkably spread, and a printer using a thermal-transfer recording (or printing) system, e.g., a thermofusible (hot-melt) transfer system or a sublimation-mode (sublimation-type) thermal-transfer system, as a small and lightweight printer has attracted attention. In the thermal-transfer recording (or printing) system, an image is formed by overlaying a recording layer of a recording sheet on an ink sheet (ink ribbon) and transferring an ink layer of the ink ribbon onto the recording layer with applying pressure and heat to a thermal head. In order to give an image having high quality printed by a thermal-transfer printer, various improvements of recording sheets are attempted. For example, there has been used a recording sheet in which a porous layer as a recording layer is formed on a sheet-like support (such as a paper, or a biaxial oriented polyethylene terephthalate film). Such a recording sheet is so excellent in ink-absorption property due to the porous layer that a uniform and vivid image can be obtained.

For instance, Japanese Patent Application Laid-Open No. 90944/1996 (JP-8-90944A) discloses an image-receiving paper for thermofusible (hot-melt) printer, which comprises a support and a polymeric porous layer formed on a surface of the support, wherein the polymeric porous layer has a mean pore size of 0.3 to 5 μm, a maximum pore size of not larger than 10 μm, and a hole density of not less than 1×10⁶/cm². This document describes that in the case where the support is a plastic film, the support may be coated with an anchor coat agent (anchor-coating agent).

Moreover, Japanese Patent Application Laid-Open No. 225560/2001 (JP-2001-225560A) discloses a recording sheet for sublimation-mode thermal-transferring, which comprises a support and a dye-receiving layer formed on at least one side of the support, wherein the dye-receiving layer comprises a dyeing resin layer formed on the support and a porous layer formed on the resin layer. This document describes a porous layer having a mean pore size of 0.05 to 3 μm and a porosity of 20 to 70%, comprising a cellulose derivative, and having a microphase-separated structure.

However, these sheets are low in the strength of the porous layer, and deteriorates in scratch resistance or abrasion resistance. In particular, in the case where the porosity is increased for improving ink-absorption property and clearness (or sharpness) of an image, white powder is generated by feeding a large number of recording sheets to a printer, resulting in tending to stain the printer.

### SUMMARY OF THE INVENTION

An object of the present invention is, therefore, to provide a recording medium which is capable of forming a clear (or distinct) or sharp image and is high in scratch resistance or abrasion resistance, and a method for producing the same.

It is an another object of the present invention to provide a recording medium having high masking property and antistatic property, and a method for producing the same.

It is a still another object of the present invention to provide a recording medium having a metallic luster and being capable of forming an image excellent in a design, and a method for producing the same.

The inventor of the present invention made intensive studies to achieve the above objects and finally found that a recording medium (sheet) in which a porous layer composed of an alicyclic epoxy compound is formed on a support ensures forming of a clear or sharp image and high scratch resistance or abrasion resistance. The present invention was accomplished based on the above findings.

That is, the recording medium (sheet) of the present invention comprises

a support and

a porous layer, for forming an image, which is formed on at least one side of the support,

wherein the porous layer comprises an alicyclic epoxy compound.

The alicyclic epoxy compound may have a plurality of epoxy groups. For example, the alicyclic epoxy compound preferably comprises a compound represented by the following formula (1):

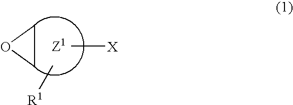

wherein Z¹ represents an aliphatic hydrocarbon ring, X represents a group having an oxirane ring, and R¹ represents a hydrogen atom or an alkyl group.

Further, X in the formula (1) preferably represents an organic group having an alicyclic epoxy ring. The alicyclic epoxy compound may be represented by the following formula (2):

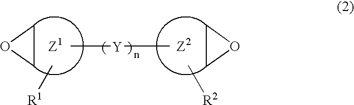

wherein Z² represents an aliphatic hydrocarbon ring or an aliphatic spiro ring, Y represents a connection group, R² represents a hydrogen atom or an alkyl group, n denotes an integer of 0 or 1, and Z¹ and R² have the same meanings as defined above.

Moreover, the alicyclic epoxy compound may be represented by the following formula (3):

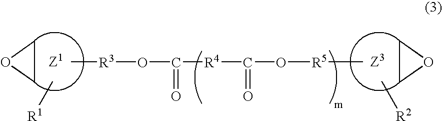

wherein Z³ represents an aliphatic hydrocarbon ring; R³, R⁴ and R⁵ each represent an alkylene or alkenylene group; m denotes an integer of 0 or 1; and Z¹, R¹ and R² have the same meanings as defined above.

The alicyclic epoxy compound may comprise an epoxy-[epoxy-oxaspiroC₈₋₁₅alkyl]-cycloC₅₋₁₂alkane, an epoxycycloalkylalkyl-epoxycycloalkane carboxylate, a bis(alkylepoxycycloalkylalkyl) dicarboxylate, and others.

The porous layer may have a mean pore size of about 0.1 to 20 μm (in particular about 0.5 to 10 μm), and a porosity of about 20 to 85% (in particular about 30 to 85%). The thickness of the porous layer may be about 3 to 50 μm (in particular about 5 to 40 μm). The porous layer may comprise a resin and an alicyclic epoxy compound, and have a microphase-separated structure. The resin may comprise a cellulose-series resin, a (meth)acrylic resin, a polysulfone-series resin, and others. In the porous layer, the ratio of the alicyclic epoxy compound may be about 1 to 200 parts by weight (in particular about 20 to 90 parts by weight) relative to 100 parts by weight of the resin. In the recording medium, the support may comprise

a support layer comprising a transparent resin,

a metal layer formed on at least one side of the support layer, and

a protecting layer formed on the metal layer; and the porous layer may be disposed on the support layer.

In the recording medium, an image may be formable onto the porous layer by means of a thermal-transfer recording system (e.g., a thermofusible (hot-melt) transfer system, a sublimation-mode (sublimation-type) thermal-transfer system) or an ink jet recording system. In the case of forming the image by means of the thermal-transfer recording system, the thickness of the porous layer is decreased to about 20 to 70% by thermal-transferring.

The present invention also includes a method for producing a recording medium, which comprises forming a porous layer for forming an image on at least one side of a support to obtain a recording medium, wherein the porous layer comprises a resin composition comprising an alicyclic epoxy compound.

### DETAILED DESCRIPTION OF THE INVENTION

The recording medium or sheet of the present invention comprises a support, and a porous layer, for forming an image, which is formed on at least one side of the support. An anchor layer may be interposed between the support and the porous layer.

[Porous Layer]

In order to improve scratch resistance or abrasion resistance, the porous layer comprises a resin composition containing an alicyclic epoxy compound.

(Resin Component)

The resin constituting the porous layer is particularly not limited as far as the resin is formable a large number of pores, and can be referred to thermoplastic resins or thermosetting resins as described in Japanese Patent Application Laid-Open No. 225560/2001 (JP-2001-225560A) or Japanese Patent Application Laid-Open No. 225547/2001 (JP-2001-225547A), and others. For instance, there may be exemplified the following resins or polymers. These resins may be used singly or in combination.

(1) Cellulose-Series Resin (Cellulose Derivative):

a cellulose ester [for example, an ester of a cellulose and an organic acid such as a cellulose acetate (acetylcellulose), a cellulose propionate, a cellulose butylate, a cellulose acetate propionate, or a cellulose acetate butylate; an ester of a cellulose and an inorganic acid such as a cellulose nitrate, a cellulose sulfate, or a cellulose phosphate; an ester of a cellulose and a mixed acid such as a cellulose nitrate acetate; and others]

a cellulose ether [for example, a methyl cellulose, an ethyl cellulose, an isopropyl cellulose, a butyl cellulose, a benzyl cellulose, a hydroxyethyl cellulose, a carboxymethyl cellulose, a carboxyethyl cellulose, a cyanoethyl cellulose, and others]

(2) Vinyl-Series Polymer:

a (meth)acrylic polymer [for example, a homo- or copolymer of a (meth)acrylic monomer (e.g., (meth)acrylonitrile, a (meth)acrylate monomer); a copolymer of a (meth)acrylic monomer and a copolymerizable monomer (a vinyl-series monomer such as a vinyl ester-series monomer, a heterocyclic vinyl-series monomer such as vinylpyrrolidone, an aromatic vinyl-series monomer, or a polymerizable unsaturated dicarboxylic acid or a derivative thereof)]; an olefinic polymer [for example, a copolymer of an olefin and a copolymerizable monomer (e.g. an ethylene-vinyl acetate copolymer, an ethylene-(meth)acrylate copolymer, a modified polyolefin)]; a halogen-containing vinyl polymer; a vinyl ester-series polymer or a derivative thereof; a heterocyclic vinyl-series polymer; an aromatic vinyl-series polymer; an allyl alcohol-series polymer; a polyvinyl ketone; a vinyl ether-series polymer; and others

(3) Polysulfone-series polymer:

a polymer having a bonding group —SO₂— in the molecule, such as a polysulfone (for example, a poly(hexamethylene sulfone)), a sulfonated polysulfone, or a polyether sulfone

(4) Polyester-Series Resin:

a polyalkylene terephthalate (for example, a homo- or copolyester containing 1,4-cyclohexanedimethylene terephthalate, ethylene terephthalate, or butylene terephthalate); a polyalkylene naphthalate (for example, a homo- or copolyester containing ethylene naphthalate, or butylene naphthalate); and others

(5) Polyamide-Series Resin:

analiphaticpolyamide (for example, nylon 6, nylon 66, nylon 610, nylon 612, nylon 11, nylon 12, and others)

(6) Polycarbonate-Series Resin:

a polymer obtainable by a reaction of a dihydroxy compound [e.g., 2,2-bis(4-hydroxyphenyl)propane (bisphenol A)] with phosgene or a carbonic acid diester (e.g., dimethyl carbonate)

(7) Polyurethane-Series Resin:

a polymer obtainable by a reaction of a polyisocyanate (e.g., tolylene diisocyanate) with a polyol (e.g., a polyethylene glycol)

(8) Polymer Derived from Epoxide:

a polyoxyalkylene glycol (for example, a polyethylene glycol, or polypropylene glycol), or an epoxy resin

There is no particularly restriction as to these resins so far as the resins are formable a large number of pores. From the viewpoint of flexibility, a thermoplastic resin is preferred. In recording with thermal-transferring, a porous layer (recording layer) of a recording sheet and an ink ribbon for transferring are heated and adhered with a thermal head to each other under a compressive force, and the ink is transferred from the ink ribbon onto the porous layer. The porous layer composed of the thermoplastic resin has deformation of compressive property (cushiony property) due to heat and pressure, and adhesive property of the porous layer to the ink ribbon can be improved, thereby ensuring uniform transferring of the ink.

As the preferred thermoplastic resin, there may be exemplified a highly heat-resistant thermoplastic resin, e.g., a cellulose-series resin [for example, a cellulose ester such as an acetylcellulose (e.g., a cellulose diacetate, a cellulose triacetate), a cellulose propionate, a cellulose butylate, a cellulose acetate propionate, a cellulose acetate butylate, or a cellulose nitrate; a cellulose ether such as an ethyl cellulose], a (meth)acrylic resin [for example, a poly(meth)acrylic acid ester such as poly(methyl methacrylate), an acrylonitrile-vinylpyrrolidone copolymer (e.g., a copolymer containing acrylonitrile at a content of 50 to 99.9 mol %), and the like], a polysulfone-series polymer (for example, a polysulfone, a polyether sulfone), and others.

Among these thermoplastic resins, the cellulose-series resin (for example, a cellulose ester such as an acetyl cellulose) is particularly preferred. The viscosity-average molecular weight of the cellulose-series resin is about 10000 to 500000, preferably about 20000 to 300000, and more preferably about 30000 to 100000. The cellulose-series resin(s) maybe used singly or in combination.

In the case of an ink jet recording system, since an ink to be used is often an aqueous ink, a hydrophilic polymer is preferred among the above-mentioned resins. The preferred hydrophilic polymer includes a polyvinyl pyrrolidone, a vinyl ether-series polymer (e.g., a poly(methylvinyl ether), a methylvinyl ether-maleic anhydride copolymer), a vinyl acetate-series polymer or a derivative thereof (a polyvinyl acetate and a partially saponified product thereof, a polyvinyl alcohol, an ethylene-vinyl acetate copolymer and a partially saponified product thereof), a polyethylene glycol, a polyethylene imine, a polyamide, a styrene-maleic anhydride copolymer or the like in addition to the above-mentioned cellulose-series resin, the above-mentioned (meth)acrylic polymer, and the above-mentioned polysulfone-series polymer. Further, a hydrophilic polymer having a group such as a polyoxyalkylene unit, an acetoacetyl group, a carboxyl group, an acid anhydride group, an amino group, an epoxy group, or a cationic group (e.g., a tertiary amino group or a quaternary ammonium salt group, or a guanidyl group) is also preferred. The hydrophilic polymer(s) may be used singly or in combination.

Incidentally, in the case of a hydrophobic polymer such as an olefinic resin (such as a polyethylene or a polypropylene), a styrenic resin (such as a polystyrene), or a fluorine-containing resin (such as a polytetrafluoroethylene), hydrophilicity may be imparted to the surface of the polymer by a method such as addition or coating of a surfactant, a wetting agent or the like, plasma treatment, or corona treatment. Such a hydrophobic polymer to which hydrophilicity is imparted also includes the foregoing hydrophilic polymer. Furthermore, for example, even in the case using an oil-based pigment ink as an ink, the hydrophilic polymer can be preferably used.

(Alicyclic Epoxy Compound)

The porous layer comprising an alicyclic epoxy compound ensures improvement in scratch resistance or abrasion resistance of the porous layer with inhibiting deterioration in image quality. The alicyclic epoxy compound is a compound at least having an epoxy group obtained by oxidizing a double bond of a cycloalkene ring with an oxidant, and preferably has a plurality (e.g., about two to four, in particular about two to three) of epoxy groups. Exemplified as such an alicyclic epoxy compound is an alicyclic epoxy compound represented by the foregoing formula (1). The alicyclic epoxy compound(s) may be used singly or in combination.

In the foregoing formula (1), as the aliphatic hydrocarbon ring represented by Z¹, for example, there may be mentioned a C₄₋₂₀cycloalkane ring such as cyclopentane, cyclohexane, cyclooctane, or cyclododecane; a crosslinking (bridging) cyclic cycloalkane ring such as norpinane or norbornane ring; and others. Among them, a C₅₋₁₆cycloalkane ring (in particular, a C₅₋₁₂cycloalkane ring such as cyclohexane or cyclooctane), etc. is preferred.

The group having an oxirane ring represented by X is not particularly limited, and may be an epoxy group, a glycidyl group, and others. The group having an oxirane ring is preferably a group having an alicyclic epoxy ring. The alicyclic epoxy ring includes an alicyclic epoxy ring corresponding to the aliphatic hydrocarbon ring represented by the above-mentioned Z¹. Such an alicyclic epoxy ring may be connected to the ring Z¹ through a connection group, or may form a spiro ring to connect to the aliphatic hydrocarbon ring represented by Z¹.

As the alkyl group represented by R¹, there may be exemplified a C₁₋₁₀alkyl group such as methyl group, ethyl group, or propyl group. Among these alkyl groups, a C₁₋₆alkyl group (in particular, a C₁₋₃alkyl group such as methyl group) is preferred. R¹ is usually a hydrogen atom or methyl group.

Among these alicyclic epoxy compounds, a compound having a plurality (e.g., about two to four, in particular about two to three) of alicyclic epoxy groups is preferred. As the compound having a plurality of alicyclic epoxy groups, a compound represented by the above-mentioned formula (2) is particularly preferred.

In the above-mentioned formula (2), as the aliphatic hydrocarbon ring represented by Z², there may be exemplified an aliphatic hydrocarbon ring similar to the above Z¹. Among them, a C₅₋₁₆cycloalkane ring (in particular, a C₅₋₁₂cycloalkane ring such as cyclohexane or cyclooctane), etc. is preferred. As the aliphatic spiro ring, there may be mentioned a C₆₋₃₀spiroalkane ring such as spirodecane or spiroundecane, and others. Among the aliphatic spiro rings, an epoxy group-free ring of rings constituting the spiro ring may be a heterocycle containing a hetero atom (e.g., a dioxaspiroundecane such as 2,4-dioxaspiro[5.5]undecane).

As the alkyl group represented by R², there may be exemplified an alkyl group similar to the above-mentioned R¹. R² is also, usually, a hydrogen atom or methyl group.

Exemplified as the connection group represented by Y is an alkylene group (for example, a C₁₋₁₂alkylene such as methylene, ethylene, or hexylene), an alkenylene group (for example, a C₂₋₁₂alkenylene such as vinylene or propenylene), a carbonyloxy group, an oxycarbonyl group, an ether group, an amide group, and others. The connection group represented by Y may be a group combined not less than two of these connection groups. Moreover, these connection groups may have a substituent group such as an alkyl group (e.g., a C₁₋₃alkyl group such as methyl or ethyl), an alkenyl group (e.g., a C₂₋₄alkenyl group such as vinyl or allyl), a hydroxyl group, or an amino group.

Incidentally, the ring Z¹ and the ring Z² may be bonded to each other without connection groups. For example, the spiro ring Z² may be bonded to the ring Z without connection groups. Such an alicyclic epoxy compound includes, for example, an epoxy-[epoxy-oxaspiroC₈₋₁₅alkyl]-cycloC₅₋₁₂alkane such as 3,4-epoxy-1-[8,9-epoxy-2,4-dioxaspiro[5.5]undecane-3-yl]-cyclohexane.

The aliphatic epoxy compound in which the ring Z¹ and the ring Z² are bonded to each other through a connection group includes a compound represented by the above-mentioned formula (3).

In the above-mentioned formula (3), exemplified as the aliphatic hydrocarbon ring represented by Z³ is an aliphatic hydrocarbon ring similar to the foregoing Z¹. The ring Z³ is preferably a C₅₋₁₆cycloalkane ring (in particular a C₅₋₁₂cycloalkane ring such as cyclohexane or cyclooctane), and others. Incidentally, the ring Z² and the ring Z³ may be different, and may be usually the same.

As the alkylene group represented by R³, for example, there may be mentioned a C₁₋₁₂alkylene group such as methylene or ethylene. As the alkenylene group, for example, there may be mentioned a C₂₋₁₂alkenylene group such as vinylene or propenylene. Among them, a C₁₋₃alkylene group such as methylene is preferred.

The alkylene group represented by R⁴ includes, for example, a C₁₋₁₂alkylene group such as methylene, ethylene, butylene, hexylene, or octylene. As the alkenylene group, for example, there may be mentioned a C₂₋₁₂alkenylene group such as vinylene or propenylene. Among them, a C₂₋₈ alkylene group such as hexylene is preferred.

As the alkylene group represented by R⁵, for example, there may be mentioned a C₁₋₁₂alkylene group such as methylene or ethylene. As the alkenylene group, for example, there may be mentioned a C₂₋₁₂alkenylene group such as vinylene or propenylene. Among them, a C₁₋₃alkylene group such as methylene is preferred.

As the alicyclic epoxy compound represented by the formula (3), for example, there may be mentioned an epoxycycloalkylalkyl-epoxycycloalkane carboxylate such as 3,4-epoxycyclohexylmethyl-3′,4′-epoxycyclohexane carboxylate, or 4,5-epoxycyclooctylmethyl-4′,5′-epoxycyclooctane carboxylate; a bis(alkylepoxycycloalkylalkyl) dicarboxylate such as bis(2-methyl-3,4-epoxycyclohexylmethyl) adipate; and the like.

Among them, an epoxycycloalkylalkyl-epoxycycloalkane carboxylate (in particular an epoxy C₅₋₁₂cycloalkylC₁₋₃alkyl-epoxyC₅₋₁₂cycloalkane carboxylate such as 4,5-epoxycyclooctylmethyl-4′,5′-epoxycyclooctane carboxylate) is preferred.

The ratio of the alicyclic epoxy compound is not particularly limited, and may be selected from the range of 1 to 200 parts by weight relative to 100 parts by weight of the resin constituting the porous layer. For example, the ratio of the alicyclic epoxy compound is about 20 to 90 part by weight, preferably about 30 to 80 parts by weight, and more preferably about 40 to 70 parts by weight relative to 100 parts by weight of the resin constituting the porous layer. The porous layer comprising the alicyclic epoxy compound having a ratio of such a range ensures keeping of flexibility of the resin component, and improvement in the strength such as scratch resistance or abrasion resistance.

The above-mentioned alicyclic epoxy compound may be used in combination with other epoxy compound(s) (for example, a glycidyl ether-based epoxy compound such as a bisphenol A-based epoxy compound, a glycidyl ester-based epoxy compound, and the like). The ratio of other epoxy compound(s) is about not more than 30% by weight (in particular not more than 10% by weight) relative to the alicyclic epoxy compound.

In order to inhibit a spread of an ink toward the lateral direction of the porous layer, the structure of the porous layer is preferably a structure in which pores are prolonged (or grown) toward the direction of the thickness of the layer, or a mesh structure. The porous layer having such a structure ensures improvement in definition and clearness (or sharpness) of an image.

The mean pore size in the surface and inside of the porous layer may be selected within the range of about 0.1 to 20 μm, preferably about 0.3 to 10 μm, and more preferably about 0.5 to 10 μm (in particular about 1 to 5 μm). For example, the porosity of the porous layer may be selected within the range of about 20 to 85%, preferably about 30 to 85%, and more preferably about 30 to 70% (in particular about 30 to 60%). According to the present invention, an image can be improved in clearness by enlarging the pore size or the porosity. Further, even in the case enlarging the pore size or the porosity, the porous layer maintains the strength thereof, and has high scratch resistance or abrasion resistance. The printing an image with a printer, therefore, ensures a clearness (or sharpness) of the printed image, and inhibits generation of white powder or the like resulted from a feed roll of the printer.

Moreover, to the porous layer the mean pore size and the porosity in the foregoing ranges impart flexibility, that is, deformation of compressive property (cushiony property), and also imparted adiathermancy. In the case of a thermal-transfer recording system, improvement in adiathermancy of the porous layer brings about inhibition in heat-radiation of a thermal head by heat transmission, thereby improving in sensitivity of printing. Further, the porous layer having the mean pore size and the porosity in the foregoing ranges is compressed to be improved in ink-fixability and density, thereby a clear or sharp image can be formed.

The thickness of the porous layer is not particularly limited, and may be selected depending on the intended purpose. For example, the thickness may be selected within the range of about 3 to 50 μm, preferably about 5 to 40 μm, and more preferably about 5 to 30 μm.

In the case of a thermal-transfer recording system, the thickness of the porous layer decreases according as the porous layer is heated and compressed by thermal-transferring. The thickness of the porous layer after thermal-transferring is about 20 to 70%, preferably about 20 to 60%, and more preferably about 20 to 50% (in particular about 30 to 40%) relative to that before thermal-transferring.

Further, the porous layer may comprises conventional additive(s), for example, a crosslinking agent, a dye fixing agent (e.g., a cationic compound such as a quaternary ammonium salt, a polymeric dye fixing agent), an organic acid (an aromatic polycarboxylic acid such as phthalic acid), a curing agent, an antifoaming agent, a coatability improvable agent, a thickener, a lubricant, a stabilizer (e.g., an antioxidant, a ultraviolet ray absorber, a thermal stabilizer, a weather (light)-resistant stabilizer), an antistatic agent, an antiblocking agent, a filler, a gelatinizer, and others.

[Support]

The support (or substrate) may comprise at least a support layer. Moreover, the support may comprise a support layer comprising a transparent resin, and a metal layer formed on at least one side of the support layer. Further, a protecting layer for protecting the metal layer may be formed on the metal later. Furthermore, in order to improve masking property and ensure an external appearance similar to a paper in the case of using the support composed of a transparent resin, a white layer or a light-reflective hypochromic layer may be formed on the protecting layer.

(Support Layer)

The material of the support layer is not particularly limited, and for example, may include a paper (e.g., a non-coated paper or a coated paper, each comprises a pulp as a main component), a fabric (e.g., a woven fabric, or a nonwoven fabric), a synthetic paper, a plastic sheet (or film), and the like. As the non-coated paper, there may be exemplified a woodfree paper, a ground wood paper, a superior woody paper, a woody paper, a gravure paper, a thin paper (e.g., an India paper, a typing or copying paper), and others. As the coated paper, there may be exemplified a Kent paper, an art paper, a coated paper, a cast paper, and others.

Exemplified as the fiber constituting the woven fabric or the nonwoven fabric is a natural fiber (e.g., a cotton, a hemp, a silk, a sheep wool, a cellulose fiber), a regenerate fiber (e.g., a rayon such as a viscose rayon), a semi-synthetic fiber (e.g., a cellulose ester-series fiber such as an acetylcellulose fiber, a cellulose ether-series fiber such as a methyl cellulose fiber), a synthetic fiber (e.g., a polyester fiber such as a polyethylene terephthalate fiber or a polybutylene terephthalate fiber; a polyolefin fiber such as a polyethylene fiber or a polypropylene fiber; a polyamide fiber such as nylon 6 fiber or nylon 66 fiber), and others. The fiber(s) may be used singly or in combination.

As the polymer constituting the synthetic paper or the plastic sheet, there may be used various thermoplastic resins or various thermosetting resins. The thermoplastic resin includes, for example, an olefinic resin (e.g., a polypropylene), a halogen-containing resin (e.g., a polyvinyl chloride), a vinyl-series resin (e.g., an ethylene-vinyl acetate copolymer), a (meth)acrylic resin (e.g., a poly(methyl methacrylate)), a styrenic resin (e.g., a polystyrene, a rubber-reinforced polystyrene, an ABS resin), a cellulose-series resin (e.g., a cellulose acetate), a polyester-series resin (e.g., a polyethylene terephthalate, a polybutylene terephthalate), a polycarbonate resin (e.g., a bisphenol A-based polycarbonate), a polyamide-series resin (e.g., an aliphatic polyamide such as nylon 6), and others. The thermosetting resin includes an epoxy resin, an unsaturated polyester resin, a diallylphthalate resin, a silicone resin, and others. Moreover, a copolymer thereof, a blended product thereof, and a crosslinked product thereof may be also used. Further, the resin(s) may be used singly or in combination, as a monolayer sheet or a laminated sheet.

Among them, from the viewpoint of improving adiathermancy or cushiony property, for example, it is preferred to use a paper comprising a cellulose as a main component (e.g., a coated paper, a laminated paper), a woven fabric or nonwoven fabric comprising a polyester fiber or a polyolefin fiber, and in view of improving transparency, it is preferred to use a synthetic paper or plastic sheet comprising a transparent resin (e.g., a polypropylene-series resin, a polyester-series resin, a polycarbonate-series resin). As the transparent resin, from the viewpoint of heat resistance, mechanical property, workability or others, it is preferred to use an aromatic polyester-series resin (e.g., a polyC₂₋₄alkylene arylate-series resin such as a polyethylene terephthalate, a polybutylene terephthalate, or a polyethylene naphthalate; a copolyester comprising a C₂₋₄alkylene arylate unit in a content of not less than 80 mol %; a liquid crystalline aromatic polyester; and the like), a polycarbonate-series resin (e.g., a bisphenol A-based polycarbonate), in particular a polyC₂₋₄alkylene arylate-series resin (e.g., a polyethylene terephthalate).

The synthetic paper or the plastic sheet may be stretched (uniaxially or biaxially stretched). Incidentally, to improve masking property and clearness or sharpness of a recorded image, the plastic sheet comprising the transparent resin may comprise a white pigment such as a titanium oxide or an extender pigment (e.g., calcium carbonate). As such a plastic sheet, there may be exemplified a polyethylene terephthalate sheet comprising a white pigment, and the like.

In the case forming the metal layer, the support layer preferably comprises the above-mentioned transparent resin.

If necessary, to the support layer may be added conventional additive(s), for example, a stabilizer (e.g., an antioxidant, a ultraviolet ray absorber, a thermal stabilizer, a weather (light)-resistant stabilizer), an antistatic agent, an antiblocking agent, a filler, a dye or pigment, an antifoaming agent, a coatability improvable agent, a lubricant, and others. In order to improve adhesiveness to other layer (such as the porous layer), the support layer may be subjected to a surface treatment such as corona discharge treatment or undercoat treatment.

The thickness of the support is not particularly limited as far as the sheet is inserted in a printer without any trouble, and may be usually selected within the range of about 5 to 500 μm, preferably about 10 to 300 aim, and more preferably about 50 to 200 μm depending on the intended purpose. In the case forming the metal layer, the thickness of the support layer comprising the transparent resin may be usually selected within the range of about 10 to 300 μm, preferably about 20 to 200 μm, and more preferably about 80 to 150 μm.

(Metal Layer)

Forming the metal layer can impart antistatic property and masking property to the recording sheet, and impart metallic luster to the record image resulting in improvement of the record image in decorative property, design, or the like. The metal layer may be formed on at least one side of the foregoing support layer, and usually, the metal layer is preferably formed on the opposite side of the support to the porous layer. For instance, the metal layer may be preformed on a surface of the support layer or protecting layer. The metal layer may be, for example, formed on the surface of the support layer or protecting layer by a vapor deposition method or other means. The vapor deposition method includes a physical vapor deposition method such as a vacuum deposition method, a sputtering method, or an ion-plating method, a chemical vapor deposition method, and others.

Exemplified as a metal constituting the metal layer is a metal which imparts electrically conductive and/or light reflectivity, for example, a metal element such as Group 4A elements of the Periodic Table of Elements (e.g., titanium, zirconium), Group 8 elements of the Periodic Table of Elements (e.g., nickel, platinum), Group 1B elements of the Periodic Table of Elements (e.g., copper, silver, gold), Group 2B elements of the Periodic Table of Elements (e.g., zinc), Group 3B elements of the Periodic Table of Elements (e.g., aluminum, indium), or Group 4B elements of the Periodic Table of Elements (e.g., silicon, tin). The metal(s) may be used singly or in combination. Among these metals, it is preferred to use a metal having conductive and being capable of forming a light reflective coat, for example, Group 3B elements of the Periodic Table of Elements (e.g., aluminum), and is particularly preferred to use aluminum.

The thickness of the metal layer is about 5 to 500 nm, preferably about 10 to 300 nm, and more preferably about 20 to 100 nm.

(Protecting Layer)

The protecting layer has a function of protection of the metal layer, and the metal layer is interposed between the support layer and the protecting layer to inhibit from curling in the sheet.

As the protecting layer, a thermoplastic resin or a thermosetting resin may be usually employed. In the case forming a white layer or a light-reflective hypochromic layer on the protecting layer, it is preferred to use a transparent resin. As the transparent resin, there may be used a thermoplastic resin or a thermosetting resin exemplified in the section of the foregoing support layer, and preferably used an aromatic polyester-series resin (e.g., a polyC₂₋₄alkylene arylate-series resin, a copolyester comprising a C₂₋₄alkylene arylate unit, a liquid crystalline aromatic polyester), or a polycarbonate resin (e.g., a bisphenol A-based polycarbonate), in particular a polyC₂₋₄alkylene arylate-series resin (e.g., a polyethylene terephthalate). The resin(s) may be used singly or in combination.

The thickness of the protecting layer is about 1 to 50 μm, preferably about 5 to 30 μm, and more preferably about 10 to 30 μm.

The ratio of the thickness of the support layer relative to that of the protecting layer [the support layer/the protecting layer] may be selected within the range of about 50/1 to 1/1, and usually about 30/1 to 2/1, preferably about 20/1 to 3/1, and more preferably about 15/1 to 4/1.

A white or light-reflective hypochromic layer may be further formed on the protecting layer. Since masking property can be further improved by forming such a layer, the support ensures an external appearance similar to a paper even in the case using a transparent resin as the support layer.

White or hypochromic (or light) color in the light-reflective hypochromic layer, for instance, means a color having a lightness of about 5 to 10, and preferably about 7 to 10. For example, such a color includes a color based on white (e.g., light yellow, pink, light blue, light gray), and the like. The white layer or light-reflective hypochromic layer is not particularly limited as far as the layer is formable a layer containing a white pigment. For example, the white layer or light-reflective layer may be adhered to a layer which comprises a resin composition containing a white pigment through a sticking layer. From the viewpoint of convenience, the white layer or light-reflective layer is preferably a layer coated on the protecting layer (coated over the whole area by means of printing or others) with a coating agent (e.g., a printing ink) containing a white pigment.

The white pigment includes a titanium-series (titanium-containing) white pigment [a titanium oxide (white titanium pigment), etc.], a zinc-series (zinc-containing) white pigment (a zinc oxide, a zinc sulfide, etc.), a composite white pigment (a lithopone, etc.), an extender pigment [a magnesium silicate, a magnesium oxide, a calcium carbonate, a barium sulfate, an aluminum-series (aluminum-containing) extender (an alumina, an aluminum hydroxide, an aluminum silicate, etc.), a silica, a mica, a bentonite, etc.], and the like. The white pigment(s) may be used singly or in combination. Among the white pigments, the titanium-series white pigment, in particular the titanium oxide, is preferred.

The white pigment(s) may be combined with color pigment(s) to make a hypochromic (or light) color having light reflectivity. As the color pigment, there may be exemplified an organic pigment [an azo pigment (e.g., a pigment yellow, a hansa yellow, a benzidine yellow, a permanent red, a brilliant carmin 6B), a phthalocyanine pigment (e.g., a copper phthalocyanine blue, a copper phthalocyanine green), a lake pigment (a lake red, a watchung red), etc.], an inorganic pigment [a black pigment (e.g., a carbon black), a yellow pigment (e.g., a chrome yellow), a red pigment (e.g., an iron oxide), an orange pigment (e.g., a molybdate orange), a green pigment (e.g., a chrome green), a blue pigment (e.g., Berlin blue), a purple pigment (e.g., a manganese violet), etc.].

The mean particle size of the pigment is, for example, about 0.001 to 1 μm, preferably about 0.01 to 1 μm, and more preferably about 0.01 to 0.5 μm.

The coating agent containing a pigment may be an aqueous (water-based) agent, and from the viewpoint of weather (light)-resistance and water resistance, the coating agent is preferably an oil-based agent. The coating agent may comprise a dispersant, a resin, a leveling agent, and others.

The thickness of the white layer or the light-reflective hypochromic layer is not particularly limited. The thickness may be selected within the range of about 0.1 to 10 μm, and is preferably about 0.5 to 5 μm, and more preferably about 1 to 5 μm.

An adhesive layer may be interposed between each layer constituting the support (for example, between the metal layer and the protecting layer, or between the support layer and the metal layer).

[Anchor Layer]

An anchor layer may be formed between the support and the porous layer. The anchor layer includes a resin having adhesiveness, for example, a thermoplastic resin (e.g., a polyamide-series resin, a polyester-series resin, a styrenic resin, a polyolefinic resin, a polycarbonate-series resin, a polyvinyl acetate-series resin, an acrylic resin, a vinyl chloride-series resin, a thermoplastic urethane-series resin), a thermosetting resin (e.g., a urethane-series resin, an epoxy-series resin, a phenol-series resin, a melamine-series resin, a urea-series resin, a silicone-series resin), a rubber-like polymer (e.g., a thermoplastic elastomer, a rubber component), and others.

Among these resins, the anchor layer preferably comprises a resin or rubber-like polymer having cushiony property. In the case recording with thermal-transferring, a porous layer of a recording sheet and an ink ribbon for transferring are heated and adhered with a thermal head to each other with experiencing to a compressive force, and the ink is transferred from the ink ribbon onto the recording layer. The anchor layer has deformation of compressive property (cushiony property), and adhesive property of the porous layer to the ink ribbon can be improved, thereby ensuring uniform transferring of the ink.

As such a resin or rubber-like polymer, there is not particularly limited as far as it has the above-mentioned cushiony property, and for example, there may be mentioned a thermoplastic polyurethane-series resin, a thermoplastic elastomer, a rubber component, and others. The resin(s) or rubber-like polymer(s) may be used singly or in combination.

The thermoplastic polyurethane-series resin includes, for example, a polyurethane-series resin at least comprising a polyether polyol (a polyoxyC₂₋₄alkylene glycol such as a polyethylene glycol) or a polyester polyol [e.g., a polyester polyol obtained from a C₄₋₁₂polybasic acid (such as adipic acid) and a polyol component (e.g., a C₂₋₁₀alkylene glycol such as ethylene glycol, the foregoing polyoxyalkylene glycol)] as a polyol component, in particular a urethane-series resin obtained from a polyol component containing not less than 50% by weight of the polyether polyol or polyester polyol.

The thermoplastic elastomer includes a styrenic thermoplastic elastomer, an olefinic thermoplastic elastomer, a polyester-series thermoplastic elastomer, a polyurethane-series thermoplastic elastomer, a polyamide-series thermoplastic elastomer, and others.

The rubber component includes, for example, a diene-series rubber, an ethylene-vinyl acetate copolymer, an acrylic rubber, an acrylic latex, a urethane rubber, a silicone rubber, a butyl rubber, and others.

The thickness of the anchor layer is about 0.3 to 20 μm, preferably about 1 to 20 μm, and more preferably about 2 to 15 μm.

[Recording Medium (Sheet)]

The recording medium (sheet) of the present invention comprises a resin composition comprising an alicyclic epoxy compound, and retains strength even in the case enlarging the pore size or porosity of the porous layer. Therefore, the recording sheet can form a clear image by excellent ink-absorption property, and has excellent scratch resistance or abrasion resistance. Moreover, a recording system is not particularly limited, and may be an ink jet recording system. Since the porous layer as a recording layer is excellent in deformation of compressive property, the recording sheet of the present invention is particularly preferably employed for a thermal-transfer recording system using a thermal head. In the thermal-transfer recording system, almost all the impressed energy of the thermal head is imparted as it is to the recording sheet, and thus dots are correctly reappeared. Further, it is possible to print highly sensitive record in a high color density. The recording sheet of the present invention is therefore suitable as a recording sheet used in a printer of a thermal-transfer recording system (e.g., a thermofusible transfer system or a sublimation-mode thermal-transfer system), in particular a printer of a thermofusible transfer system.

Incidentally, the thermofusible transfer system is not particularly limited as far as the system ensures coloration with transferring of a hot-melt (or fused) ink, and for example, may be a system using a medium (such as an ink ribbon) composed of a support and a transfer layer, in which the transfer layer is formed on the support and separable therefrom, and comprises a coloring agent and a thermofusible (hot-melt) component (e.g., a resin, a wax). Moreover, the sublimation-mode thermal-transfer system is not particularly limited as far as the system ensures coloration with a sublimatic coloring agent, and for example, may be a system using a medium (such as an ink ribbon) composed of a support (in particular a polyethylene terephthalate having excellent heat resistance, etc.) and a dye feed layer, in which the dye feed layer is formed on the support, and comprises a sublimatic coloring agent and a binder resin.

According to the present invention, an image may be formed by the following process: recording an image onto the porous layer by a thermal transfer system, and coating the side of the resulting transfer image with a fused transparent resin to form an overcoat layer. As the method for forming the overcoat layer, for example, there may be mentioned a method of transferring an overcoat layer by heating and pressurizing a medium having the overcoat layer as a transfer layer with a thermal head, a heat-lamination method, or others. Incidentally, in a conventional sheet, in the case where an ink color-printed by thermal-transferring a thermal-transfer ink (in particular yellow, cyan, magenta, and optionally black ink) is coated with a thermofusible (hot-melt) overcoat layer having a high-melting point, the ink melts and spreads along the sheet surface, and image clearness is deteriorated. On the other hand, according to the present invention, the porous layer can absorb an ink, and in the case where the porous layer compressed with heat and pressure of the thermal head is coated with the above-mentioned overcoat layer, the image is improved in durability or scratch resistance.

The wax or resin constituting the above-mentioned overcoat layer is preferably a wax or resin having a melting point of about 40 to 180° C., preferably about 50 to 160° C., and more preferably about 65 to 140° C. (in particular 70 to 120° C.). Such a wax or resin includes, for example, a wax of vegetable origin (e.g., a carnauba wax, a candelila wax), a wax of animal origin (e.g., a shellac wax, an insect wax, a wool wax), a mineral wax (e.g., a montan wax, an ozokerite), a petrolic wax (e.g., a paraffin wax, a mycrocrystalline wax, a petrolatum), a synthetic wax (e.g., an olefinic wax such as a polyethylene wax or a polypropylene wax, an olefinic copolymer wax such as an ethylene-maleic anhydride copolymer wax or a propylene-maleic anhydride copolymer wax), a higher fatty acid (e.g., stearic acid, arachidic acid, behenic acid), a thermoplastic resin (e.g., an olefinic resin such as a polypropylene, an ethylene-vinyl acetate copolymer, or an ethylene-acrylic acid copolymer, a polyamide-series resin, a polyester-series resin, an acrylic resin, a polyurethane-series resin, a rosin-series resin such as a rosin ester), a thermoplastic elastomer (e.g., a natural rubber, a styrene-butadiene rubber), and others.

Among these waxes and resins, it is particularly preferred to use a wax or resin which has melting point higher than that of a thermofusible (hot-melt) binder resin constituting an ink in thermofusible transferring (sublimation temperature thereof in sublimation-mode thermal transferring), and for example, the melting point of the wax or resin is about 10 to 50° C. (preferably about 20 to 50° C., and more preferably about 30 to 50° C.) higher than that of the thermofusible binder resin.

The thickness of the overcoat layer is about 0.5 to 50 μm, preferably about 1 to 30 μm, and more preferably about 2 to 10 μm.

[Production Process]

The recording sheet of the present invention can be produced by forming a porous layer for forming an image, on at least one side of a support.

The porous layer may be produced by the following methods: a phase separation method which comprises microphase-separating a polymer with the use of a good solvent and a poor solvent; a foam method which comprises allowing to foam a polymer to form pores; an irradiation method which comprises exposing a resin layer to radiation for forming pores; an extraction method which comprises extractively removing a component soluble to a solvent from a film comprising a polymer or inorganic base soluble to the solvent and a polymer insoluble to the solvent for forming pores; a sinter method which comprises partial-adhering polymer particles or strengthening polymer particles with a binder to utilize a void formed between the particles as a pore; and others.

Among these methods, a phase separation method which comprises microphase-separating a polymer with the use of a good solvent and a poor solvent is preferably employed. The microphase-separation method includes, for example, a dry phase-inversion method, or a wet phase-inversion method, and a dry phase-inversion method is particularly preferred from the viewing of excellent mass production. For example, the detail of a dry phase-inversion method can be referred to Japanese Patent Application Laid-Open No. 225560/2001 (JP-2001-225560A), or Japanese Patent Application Laid-Open No. 225547/2001 (JP-2001-225547A).

The production method of the porous layer by use of a dry phase-inversion method is, for example, described as the follows: a liquid coating composition comprising a polymer, a good solvent to the polymer, and a poor solvent to the polymer and having a boiling point higher than that of the good solvent is coated on a support, and dried to vaporize the good solvent having lower boiling point in advance. In so doing, solubility of the polymer is deteriorated in accordance with progress of vaporization of the good solvent, and the polymer forms a micell to phase-separate from the poor solvent phase. Further, in progressing vaporization of the poor solvent, the micell is contacted with each other to form a mesh structure, and by completing vaporization of the poor solvent, a porous layer is formed.

As the good solvent, depending on species of the polymer, there maybe mentioned, for example, a ketone (e.g., a C₃₋₆dialkyl ketone such as acetone or methyl ethyl ketone, cyclohexanone); an ester (e.g., a C₁₋₄alkyl ester of formic acid such as ethyl formate, a C₁₋₄alkyl ester of acetic acid such as ethyl acetate); an ether (e.g., a cyclic or linear C₄₋₆ether such as 1,4-dioxane or tetrahydrofuran); a cellosolve (e.g., a C₁₋₄alkyl cellosolve such as methyl cellosolve); a cellosolve acetate (e.g., a C₁₋₄alkyl cellosolve acetate such as methyl cellosolve acetate); an aromatic hydrocarbon (e.g., benzene, toluene); a halogenated hydrocarbon (e.g., methylene chloride); an amide (e.g., formamide, acetamide); a sulfoxide (e.g., dimethyl sulfoxide); a nitrile (e.g., acetonitrile); an organic acid (e.g., acetic acid); an organic acid anhydride (e.g., maleic anhydride, acetic anhydride); and a mixture thereof. Incidentally, the good solvent sometimes acts as a poor solvent depending on the species of resin.

More specifically, in the case using a cellulose derivative as the polymer, the preferred good solvent includes a C₃₋₆dialkyl ketone (e.g., acetone, methyl ethyl ketone); a C₁₋₄alkyl ester of acetic acid (e.g., ethyl acetate, butyl acetate); a cyclic or linear C₄₋₆ether (e.g., dioxane, dimethoxyethane); a C₁₋₄alkyl cellosolve (e.g., methyl cellosolve, methyl cellosolve acetate); or a mixture thereof. In particular, a C₃₋₆dialkyl ketone such as acetone or methyl ethyl ketone, a C₁₋₄alkyl cellosolve such as methyl cellosolve, or others is preferred.

The poor solvent means a solvent having insolubility or low solubility to the polymer to be used, and species of the solvent is not particularly limited as far as the boiling point thereof is higher than that of the good solvent. As the poor solvent, there may be mentioned, for example, water; an ester [for example, a C₅₋₈alkyl ester of formic acid (such as amyl formate), a C₄₋₁₀alkyl ester of a C₂₋₄aliphatic carboxylic acid which may have a C₁₋₄alkoxy group (e.g., amyl acetate, or butyl propionate), a C₁₋₄alkyl ester of benzoic acid such as methyl benzoate]; an alcohol (for example, a C₄₋₁₀alcohol such as amyl alcohol, a heterocyclic alcohol); an aliphatic polyhydric alcohol (e.g., ethylene glycol, a polyethylene glycol, glycerin); and a mixture thereof.

More specifically, in the case using a cellulose derivative as the polymer, the preferred poor solvent includes water; a lower alcohol (e.g., a C₁₋₄alkyl alcohol such as methanol or ethanol); a C₅₋₈alkyl ester of formic acid (e.g., amyl formate); a cycloalkanol (for example, a C₄₋₈cycloalkanol which may have a C₁₋₄alkyl group as a substituent, e.g., cyclohexanol or methylcyclohexanol); a C₁₋₄alkyl ester of benzoic acid (e.g., methyl benzoate, ethyl benzoate); or a mixture thereof. In particular, a cycloalkanol such as cyclohexanol, a lower alcohol such as propanol, or water is preferred.

The ratio of the good solvent relative to the poor solvent in the liquid coating composition is usually about 0 to 300 parts by weight, and preferably about 3 to 250 parts by weight of the poor solvent relative to 100 parts by weight of the good solvent. The content of the resin in the liquid coating composition is about 1 to 30% by weight, preferably about 1 to 25% by weight, and particularly 3 to 20% by weight (e.g., about 3 to 15% by weight).

The coating method of the porous layer is not particularly limited, and for example, a known method such as a bar system or a roll system is applicable.

The porous layer can be obtained through the foregoing coating and drying steps, and further may be subjected to final treatment for smoothing the surface thereof. As the smoothing treatment of the porous layer surface, there may be used a machine calender comprising double or more metal rolls, a super calender comprising a metal roll and a resinous roll, or others without bringing the pores to destruction (e.g., under a moderate pressure condition).

In the printing sheet of the present invention, the porous layer may be usually obtained by coating the liquid coating composition containing the polymer on the support to form pores of the porous layer in a film-forming step, or by laminating the support with a porous layer separately prepared in a dry phase-inversion method or the like.

The anchor layer interposed between the support and the porous layer can be formed by coating at least one side of the support with a coating agent containing a component of the anchor layer before forming the porous layer, and if necessary drying the coating agent. The coating agent may be usually employed in the form of an organic solvent solution, an aqueous solution, or an aqueous emulsion. The coating method of the anchor layer is not particularly limited, and the same method as in the porous layer is applicable.

The lamination method of a metal layer-deposited support layer and a protecting layer, or a metal layer-deposited protecting layer and a support layer includes a conventional lamination method such as a dry lamination method. As an adhesive used in dry lamination, for example, there may be used an adhesive resin exemplified in the section of the foregoing anchor layer.

The recording sheet of the present invention is suitable for a thermal-transfer recording system, and is useful as a recording sheet for a thermal-transfer system printer associated with various apparatuses such as a video camera, a telephone, or a computer [in particular a printer associated with mobile (portable) electrical or communication apparatuses (or devices) or information and communication apparatuses (or devices), e.g., a potable telephone or a digital camera]. The printer associated with the apparatuses includes a printer built-in or connected with the apparatuses, and others. Since the printer of these mobile apparatuses runs on batteries, use of a recording sheet having high recording property saves power to ensure increasing of the number of pieces printable per charge of the battery, and ensures prolonging drive time. Further, the recording sheet of the present invention is excellent in paper-feeding property and excellent in adhesiveness to a thermal head, and is useful for printers of mobile apparatuses.

According to the present invention, the printing sheet ensures forming of a clear image and improvement in scratch resistance or abrasion resistance due to the porous layer comprising an alicyclic epoxy compound. Moreover, the printing sheet realizes excellent masking property and antistatic property by forming the metal layer on at least one side of the support. Further, the recording sheet has a metallic luster, and is formable an image excellent in a design.

### EXAMPLES

The following examples are intended to describe this invention in further detail and should by no means be interpreted as defining the scope of the invention.

In each recording sheet obtained in Examples and Comparative Examples, reflectance optical density, roundness of dot, masking property, antistatic property, stiffness of sheet, layer strength, and generation of white powder were evaluated as follows.

[Reflectance Optical Density]

A predetermined image was printed onto the printing sheet by using a ink ribbon having an ink layer (cyan, magenta, and yellow) and an overprint layer [a mixture of a paraffin wax having a melting point of 75° C. and a candelila wax having a melting point of 70° C. (the former/the latter=2/1 (weight ratio)), 1 μm in thickness] with the use of a color mobile printer (manufactured by J-Phone Co., Ltd., J-SH04) to form a record image. About the obtained record image, the reflection density of black in 100% tone part and that of each color (cyan, magenta, and yellow) in 10% tone part were measured by use of a reflection-mode (reflection-type) Macbeth densitomater RD-914.

[Roundness of Dot]

In the same manner as in the measurement of reflectance optical density, an image was printed onto the recording sheet. About a record image transferred onto the printing sheet, the printed dot in cyan 50% tone part was observed with a CCD camera (400-fold), and the roundness of dot was evaluated on the basis of the following criteria.

“A”: the shape of the dot is almost round

“B”: the shape of the dot is not round

[Masking Property]

The total light transmittance of the recording sheet was measured with a hazemeter in accordance with JIS K7105, and evaluated on the basis of the following criteria.

“A”: less than 20%

“B”: not less than 20%

[Antistatic Property]

The surface resistance of the recording sheet was measured in accordance with ASTM-D257, and evaluated on the basis of the following criteria.

“A”: less than 10¹³ Ω/□

“B”: not less than 10¹³ Ω/□

[Stiffness of Sheet]

The tensile modulus of the recording sheet was measured in accordance with JIS K7127, and evaluated on the basis of the following criteria.

“A”: not less than 2000 MPa

“B”: less than 2000 MPa

[Layer Strength]

In the same manner as in the measurement of reflectance optical density, an image was printed onto the recording sheet. An adhesive tape (manufactured by Nichiban Co., Ltd., No. 405) was attached on the surface of the printed side of the recording sheet. Then, the adhesive tape was slowly peeled from the recording sheet by hand, and the state of the surface of the printed side was visually observed and evaluated on the basis of the following criteria.

“A”: the adhesive tape come off the overprint layer, thereby the print image was not damaged

“B”: the porous layer was partially broken, and the print image was damaged

“C”: the porous layer was broken in a whole area adhered to the adhesive tape, and the print image was damaged

[Generation of White Powder]

In the same manner as in the measurement of reflectance optical density, an image was printed onto the recording sheet, and the ink ribbon was taken out. The state of the surface in the cyan ink part of the ink ribbon was visually observed, and evaluated on the basis of the following criteria.

“A”: no remarkable deposit was present on the surface of the ink ribbon

“B”: a large amount of white powdery substance was adhered to the surface of the ink ribbon

### Example 1

A support layer comprising a transparent polyethylene terephthalate film 125 μm thick (manufactured by Teijin Dupont Films Japan Ltd.), and a protecting layer comprising an aluminum-deposited polyethylene terephthalate film 25 μm thick (manufactured by Toyo Metallizing Co., Ltd.) were subjected to dry lamination with the aluminum-deposit layer inside to prepare a support 150 μm thick. A polyurethane emulsion (manufactured by Senka Co., Ltd., KT-05R) was coated on the support layer of the support by use of a dye coater, and dried to obtain a sheet having an anchor layer 3 μm thick. Moreover, to a resin solution (45 parts by weight) comprising 5 parts by weight of a cellulose acetate (manufactured by Daicel Chemical Industries, Ltd., L70) and 40 parts by weight of acetone as a good solvent were added cyclohexanol (40 parts by weight), isopropyl alcohol (10 parts by weight), and water (5 parts by weight) as a poor solvent, and further added 3,4-epoxycyclohexylmethyl-3′,4′-epoxycyclohexane carboxylate (manufactured by Daicel Chemical Industries, Ltd., CELLOXIDE 2021P) (3 parts by weight) to prepare a liquid coating composition. The liquid coating composition was coated on the anchor layer of the sheet by use of a dye coater, dried at 80° C. to form a porous layer, and a recording sheet was obtained. The mean pore size of the porous layer was 1.5 μm, the porosity thereof was 40%, and the thickness thereof was 15 μm. Moreover, the thickness of the porous layer after thermal-transferring was 35% of the thickness before thermal-transferring.

### Example 2

A recording sheet was obtained in the same manner as in Example 1 except that a white ink (manufactured by Toyo Ink Mfg. Co., Ltd., LPVMS) was further solid-printed on the protecting layer at a thickness of 2 μm.

### Comparative Example 1

A recording sheet was obtained in the same manner as in Example 1 except that 3,4-epoxycyclohexylmethyl-3′,4′-epoxycyclohexane carboxylate was not added to the porous layer, and that a transparent polyethylene terephthalate film 25 μm thick (manufactured by Teijin Dupont Films Japan Ltd.) was used instead of the aluminum-deposited polyethylene terephthalate film 25 μm thick as the protecting layer.

### Comparative Example 2

A recording sheet was obtained in the same manner as in Comparative Example 1 except that 3,4-epoxycyclohexylmethyl-3′,4′-epoxycyclohexane carboxylate was not added to the porous layer, and that a white ink (manufactured by Toyo Ink Mfg. Co., Ltd., LPVMS) was further solid-printed on the protecting layer at a thickness of 2 μm.

### Comparative Example 3

A recording sheet was obtained in the same manner as in Example 1 except that 3,4-epoxycyclohexylmethyl-3′,4′-epoxycyclohexane carboxylate was not added to the porous layer, and that a white polyethylene terephthalate film 150 μm thick (manufactured by Toray Industries, Inc., 150E60L) was used as a support.

### Comparative Example 4

As a recording sheet, a porous film 150 μm thick (manufactured by Toyobo Co., Ltd., Crisper K2323) was used. The mean pore size of the pores was 8 μm, and the porosity of the porous film was 20%. Moreover, the thickness of the porous film after thermal-transferring was 97% of the thickness before thermal-transferring.

Table 1 shows evaluation results of recording sheets obtained in Examples 1, 2 and Comparative Examples 1 to 4.

TABLE 1

| | Density of | Density of each color in | | | | | Anti- | | | Generation |
|---|---|---|---|---|---|---|---|---|---|---|
| | black in 100% | 10% tone part | | | Roundness | Masking | static | Stiffness | Layer | of white |
| | tone part | Cyan | Magenta | Yellow | of dot | property | property | of sheet | strength | powder |
| Ex. 1 | 1.89 | 0.2 | 0.23 | 0.21 | A | A | A | A | A | A |
| Ex. 2 | 1.89 | 0.2 | 0.23 | 0.21 | A | A | A | A | A | A |
| Com. Ex. 1 | 1.87 | 0.2 | 0.23 | 0.21 | A | B | B | A | B | B |
| Com. Ex. 2 | 1.87 | 0.2 | 0.23 | 0.21 | A | B | B | A | B | B |
| Com. Ex. 3 | 1.87 | 0.2 | 0.23 | 0.21 | A | A | B | B | B | B |
| Com. Ex. 4 | 1.43 | 0 | 0 | 0 | B | A | B | B | B | B |

As apparent from Table 1, each recording sheet obtained in Examples is excellent in all of color density, clearness of image, masking property, antistatic property, stiffness of sheet, layer strength, and generation of white powder. On the other hand, each of the sheets in Comparative Examples is low in antistatic property and layer strength, generates a white powder, and some of these sheets deteriorates in clearness of image, masking property, or others.

What is claimed is:

1. A recording medium comprising
a support and
a porous layer, for forming an image, which is formed on at least one side of the support,
wherein the porous layer comprises an alicyclic epoxy compound.

2. A recording medium according to claim 1, wherein the alicyclic epoxy compound has a plurality of epoxy groups.

3. A recording medium according to claim 1, wherein the alicyclic epoxy compound comprises a compound represented by the following formula (1): 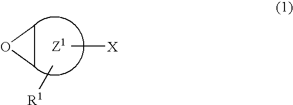
wherein Z¹ represents an aliphatic hydrocarbon ring, X represents a group having an oxirane ring, and R¹ represents a hydrogen atom or an alkyl group.

4. A recording medium according to claim 3, wherein X in the formula (1) represents an organic group having an alicyclic epoxy ring.

5. A recording medium according to claim 1, wherein the alicyclic epoxy compound is represented by the following formula (2): 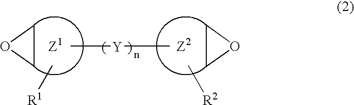
wherein Z² represents an aliphatic hydrocarbon ring or an aliphatic Spiro ring, Y represents a connection group, R² represents a hydrogen atom or an alkyl group, n denotes an integer of 0 or 1, and Z¹ and R¹ have the same meanings as defined above.

6. A recording medium according to claim 1, wherein the alicyclic epoxy compound is represented by the following formula (3): 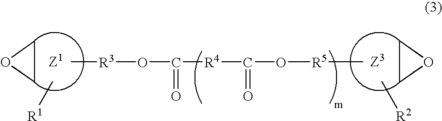
wherein Z³ represents an aliphatic hydrocarbon ring; R³, R⁴ and R⁵ each represent an alkylene or alkenylene group; m denotes an integer of 0 or 1; and Z¹, R¹ and R² have the same meanings as defined above.

7. A recording medium according to claim 1, wherein the alicyclic epoxy compound comprises at least one member selected from the group consisting of an epoxy-[epoxy-oxaspiroC₈₋₁₅alkyl]-cycloC₅₋₁₂alkane, an epoxycycloalkylalkyl-epoxycycloalkane carboxylate, and a bis(alkylepoxycycloalkylalkyl) dicarboxylate.

8. A recording medium according to claim 1, wherein the porous layer has a mean pore size of 0.1 to 20 μm, and a porosity of 20 to 85%.

9. A recording medium according to claim 1, wherein the thickness of the porous layer is 3 to 50 μm.

10. A recording medium according to claim 1, wherein the porous layer comprises a resin and an alicyclic epoxy compound, and has a microphase-separated structure.

11. A recording medium according to claim 10, wherein the resin comprises at least one member selected from the group consisting of a cellulose-series resin, a (meth)acrylic resin and a polysulfone-series resin.

12. A recording medium according to claim 10, wherein the ratio of the alicyclic epoxy compound is 1 to 200 parts by weight relative to 100 parts by weight of the resin.

13. A recording medium according to claim 1, wherein the support comprises
a support layer comprising a transparent resin,
a metal layer formed on at least one side of the support layer, and
a protecting layer formed on the metal layer.

14. A recording medium according to claim 13, wherein the porous layer is disposed on the support layer.

15. A recording medium according to claim 1, wherein an image is formable onto the porous layer by means of a thermal-transfer recording system or an ink jet recording system.

16. A recording medium according to claim 1, wherein an image is formable onto the porous layer by means of a thermofusible transfer system or a sublimation-mode thermal-transfer system.

17. A recording medium according to claim 16, the thickness of the porous layer is decreased to 20 to 70% by thermal-transferring.

18. A recording medium comprising a support and a porous layer, wherein the porous layer for forming an image by thermal-transferring is formed on at least one side of the support, and the porous layer comprises a composition containing 20 to 90 parts by weight of an alicyclic epoxy compound relative to 100 parts by weight of a resin, and has a mean pore size of 0.5 to 10 μm, a porosity of 30 to 85% and a thickness of 5 to 40 μm.

19. A method for producing a recording medium, which comprises forming a porous layer for forming an image on at least one side of a support to obtain a recording medium, wherein the porous layer comprises a resin composition comprising an alicyclic epoxy compound.
